(19) United States
(12) Patent Application Publication
(10) Pub. No.: US 2012/0271738 A1
(43) Pub. Date: Oct. 25, 2012

(54) Online Marketplace Portal for Content Publishers and Content Creators

(76) Inventors: Allen Narcisse, Los Angeles, CA (US); William Momary, Santa Clarita, CA (US)

(21) Appl. No.: 13/536,242

(22) Filed: Jun. 28, 2012

Related U.S. Application Data
(62) Division of application No. 13/049,434, filed on Mar. 16, 2011.
(60) Provisional application No. 61/314,887, filed on Mar. 17, 2010.

(51) Int. Cl. G06Q 30/00

(52) U.S. Cl. 705/27.1

(57) ABSTRACT

An online marketplace portal enables the exchange of content and payments for content between content publishers and content creators, such as organizations and professional freelancers, respectively. The online portal allows publishers and creators to exchange exclusive content concepts and completed works through a closed platform. Users can negotiate terms relating to access and rights to publish content, manage distribution of content, and process payment through the online portal. Content publishers can use the online marketplace portal to purchase syndicated content and manage relationships with freelancers.

### CROSS-REFERENCE TO RELATED APPLICATIONS

This application is a divisional application of pending U.S. patent application Ser. No. 13/049,434 (Attorney Docket No. EBY.03), filed on Mar. 16, 2011, which claimed priority to U.S. Provisional Application No. 61/314,887 (Attorney Docket No. EBY.01), filed Mar. 17, 2010, entitled “Online Marketplace Portal for Content Publishers and Content Creators,” each of which is hereby incorporated by reference as to its entire contents.

### TECHNICAL FIELD

Aspects described herein relate to an online marketplace portal for content licensing and related services.

### BACKGROUND

Content publishers and content providers often license content—including articles, photography, creative art, multimedia, and more—from sources outside their respective organizations, primarily from freelance contributors and/or syndicated content services, such as Associated Press, New York Times News Service, Bloomberg, and United Feature Syndicate. Publishers and content providers use such external content sources to control costs. For example, a newspaper may license content from the Associate Press instead of maintaining a foreign news bureau. An online content publisher may license content from freelancers for specific story concepts without having to hire a full time contributor. A radio station may purchase a nationally syndicated, nationally marketed program from Westwood One instead of recruiting and promoting their own on-air talent. However, these costs savings are offset by the administrative costs associated with managing relationships with freelancers, and by the inflexibility of the licensing models of larger syndicated content services.

Content providers typically manage and pay freelancers through a series of manual steps that vary based on the publisher. In the newspaper sector, editors find freelancers through a variety of channels, often at the freelancer's initiative through cold query letters, calls or emails through which they pitch editors on story concepts. When an editor selects a story from a freelancer, the freelancer typically signs an independent contractor agreement including stipulations such as: agreeing not to sell the story concept to another publisher, representing that their work is original, and/or agreeing to specific distribution and resale rights. Stipulations may vary from periodical publishing industry sector to sector: many newspapers prefer to own all distribution and resale rights to content; whereas magazines and radio stations may allow the freelancer to keep resale rights, with some limitations (e.g., for a specific scope of use or medium). While the independent contractor agreement typically covers all work completed by a freelancer for a publisher, work fees (including kill fees) are typically agreed to verbally or via an email on a project-by-project basis. While working on a project, a freelancer will submit drafts to an editor for review. Once the final draft is approved, the work is published by the editor's organization. Freelancers typically send a written invoice to the publisher for the completed work (although some organizations have processes to generate an accounting transaction internally without notification from the freelancer. Some organizations use software solutions to receive pitches from freelancers. However, there is no system to manage the flow of rights, stipulations, and compensation associated with the development and licensing of content for publication. As a result, publishers waste time and money managing their relationships with freelancers.

Subscribing to syndicated content services can address some of the issues associated with working with freelancers, but creates new issues in their stead. Syndicated content services usually provide publishers access to a vast amount of content in exchange for an annual fee governed by a multi-year agreement. Moreover, syndicated content services often use a single distribution system to provide content to subscribing publishers: in the newspaper industry, for example, most syndicated content—regardless of the source—is distributed through the Associated Press' AP Exchange distribution system. Publishers benefit from not having to manage relationships with all of the content creators affiliated with the syndicated content service.

However, syndicated content services offer inflexible pricing models that are increasingly incompatible with many publishers' business needs. Syndicated content services have built their business model around aggregating large amounts of content, and have not shown a willingness to provide the a la carte flexibility with pricing and content publishers have with freelancers. As such, publishers seeking to cut costs have had to reduce the number of subscription services they employ, acknowledging that they risk weakening the scope and/or quality of their publication through the loss of entire libraries of content.

Publishers also lack a platform to exploit yet another source of externally produced content: other publishers. Content produced by one publisher's in-house content creator may be of use to other publishers; however, it is believed that no platform currently exists to facilitate the transfer of rights to that content. Some large publishers (e.g., the New York Times in the newspaper industry) have created their own syndicated content service to market the content they produce; however, publisher-owned syndicated content services offer the same inflexible pricing models as their competitors. Further, no distribution platform exists that can manage direct sales and/or licensing between two parties—be they publishers, content providers, or both—on a project-by-project basis.

### BRIEF DESCRIPTION OF THE INVENTION

An online marketplace portal enables the exchange of content and payments for content between content publishers and content creators. The online portal may enable publishers and freelance content providers to exchange both completed works and exclusive concepts (e.g., pitches and ideas for content from freelancers, assignments and requests for content from publishers) via a secure network. Publishers and creators may use the portal to negotiate work-for-hire terms and collaborate on works in progress. The online portal may manage various elements of payment processing, such as collection of payment, receipt of payment, tax reporting, and 1099 distribution, if necessary.

The online marketplace also may allow publishers to grant republishing rights to content to other publishers on an a la carte basis, as well as on a subscription basis. The portal may receive content feeds from publishers seeking to market their content for republishing, organize and/or catalog the content in a way that allows purchasing publishers to search for content, and deliver selected content to a licensee's content management system. The portal can manage payment collection and distribution for any publisher-to-publisher license executed within the platform. Publishers can use the platform to collaborate in a variety of ways, including the creation of content sharing pools.

Such a portal may provide content purchasers with a marketplace featuring a wider variety of content choices, coupled with the lower financial commitment associated with a la carte pricing. Publishers using the portal will be able to manage relationships with freelance content providers more efficiently, saving time and resources.

The portal would also provide content licensors—including both freelancers and publishers seeking to republish content—with a retail environment for content exchange. Content licensors using the portal will be able to better identify and efficiently negotiate terms with interested content purchasers, thereby increasing revenue and reducing transaction costs.

### BRIEF DESCRIPTION OF THE DRAWINGS

FIG. 1 is a block diagram depicting an overview of an embodiment of an online marketplace portal.

FIG. 2 is a flow chart depicting a process by which a publisher can use the portal to purchase a completed work from a content licensor.

FIG. 3 is a flow chart depicting a process by which a freelance content creator can use an embodiment of the portal to submit a pitch for a yet-to-be completed work to a publisher.

FIG. 4 is a flow chart depicting a process by which a publisher can use an embodiment of the portal to submit an assignment for completion by a freelance content creator.

FIG. 5 is a flow chart depicting a process by which a publisher can use the portal to assign editing and/or other post-production tasks relating to a content creator's work to an intermediary editor.

### DETAILED DESCRIPTION OF AN EMBODIMENT

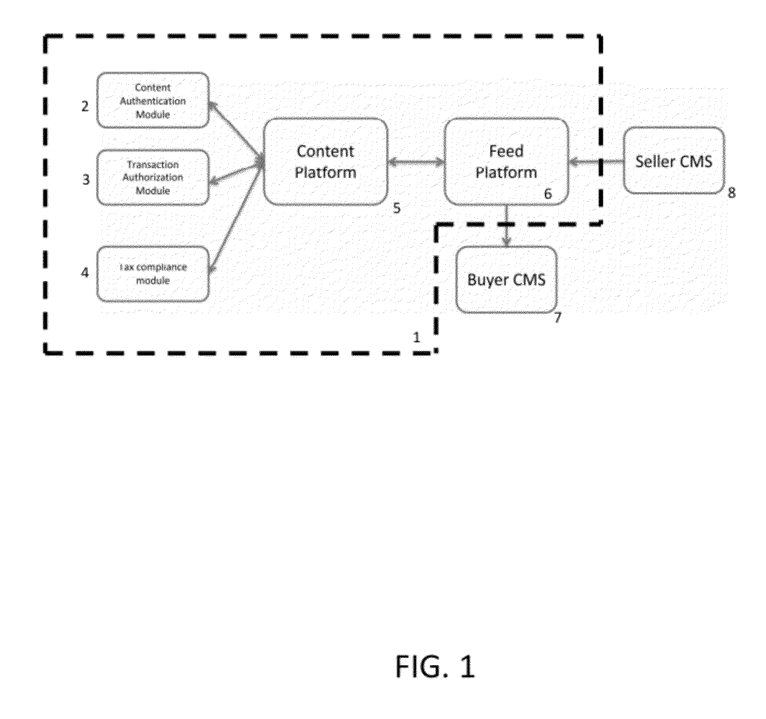

In FIG. 1, an embodiment of an online marketplace portal comprises a portal server 1 with a content platform 5 and a feed platform 6. The content platform 5 is an application that sorts content and pitches, manages terms and conditions between licensees and licensors, manages pricing information, manages the negotiation of terms between parties, archives transaction history, stores licensor information, and delivers purchased content to licensees via feed platform 6. In this context, a licensor can be any entity seeking to sell, license out, or otherwise grant access to content; and a licensee can be any entity seeking to buy, license in, gain access to, publish, or otherwise use content. According to one aspect, the content platform 5 includes a recommendation engine that would provide intelligent search results and content recommendations to content licensees.

The feed platform 6 is an application that collects, parses, and delivers content to and from multiple licensee content manager systems 7 and multiple licensor content manager systems 8. The feed platform 6 can be connected to licensee content manager systems 7 and licensor content management systems 8 via the internet, or via a secure internal network. Content creators can deliver content via the feed platform 6 to the content platform 5 in a variety of ways, including manually via an online interface (e.g., a website), or via a custom XML/RSS feed.

In this embodiment, the content platform 5 incorporates an authentication application 2 to perform plagiarism analysis of content submitted by content creators, a transaction authorization application 3 to conduct payment transactions, and a tax compliance application 4 to manage the processing of tax and freelance income reports for content creators. These applications can be created using APIs. In one embodiment, an authentication application 2 can be comprised of an API and a backup process with human review when necessary. Additional ancillary applications and APIs can be incorporated to provide customizable functionality as needed.

In a further embodiment, “editors”—e.g., intermediary service providers, such as copy editors, music engineers, technicians, colorists, film editors, sound editors, graphic designers, layout specialists, and any other entity that can hired to edit, refine, or otherwise modify content—can use their own content management systems to receive and deliver to and from the feed platform 6 as well.

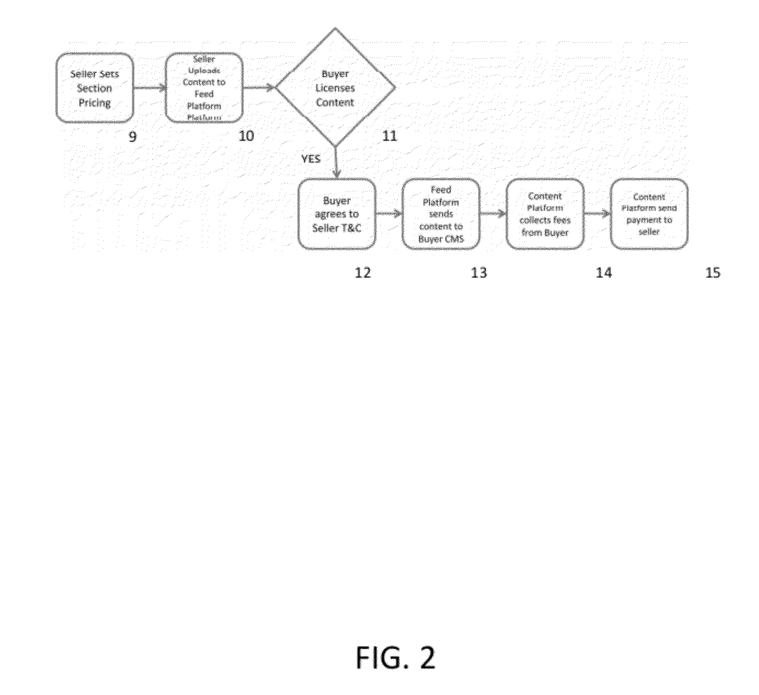

In the process in FIG. 2, a content creator can initiate a process to sell content comprising finished works via the online marketplace portal. In a further embodiment, both freelance content creators and publishers and media companies with content available for purchase can initiate this process as a content creator. In the first action 9, a licensor sets default terms and conditions for each content section or category (e.g., travel, local news, sports, etc.); then, in the subsequent action 10, the licensor begins to upload content to the content platform 5 via the feed platform 6. According to one aspect, future content uploaded to the content platform 5 by a content creator will be automatically tagged with default licensing terms and conditions, according to its content classification. Licensors can change the default section pricing, or the pricing on individual works after uploading to the content platform 5 at any time.

According to one aspect, the licensor can also adjust specific terms and conditions for all of selected content uploaded to the content platform; these terms and conditions may include: distribution rights provisions; resale provisions; conditions of republishing; etc. In this embodiment, a licensor would be able to restrict specific licensees from being authorized to purchase content. As an example, a publisher acting as a licensor may seek to prevent regional competitors from purchasing content, while still allowing licensees in more distant geographical markets to purchase that content. In another embodiment, a licensor would be able to set specific terms and conditions for multiple pools of licensees as defined by the licensor; such that each pool would be entitled to a different set of terms and conditions for the entire pool. In the following event 11, a licensee searching for content on the content platform 5 can identify and license content from the licensor. In the next action 12, the licensee agrees to the licensor's terms and conditions. In a further embodiment, the licensee will also agree to the terms and conditions associated with the use of the online marketplace portal. Once the licensee agrees, the content platform 5 sends the purchased content to the licensee's content management system 7 via the feed platform 6 in the subsequent action 13. In the following event 14, the content platform 5 collects payment from the licensee. In a further embodiment, the content platform will automatically invoice the licensee for the licensor's previously declared price plus a transaction fee; the licensor can submit payment in a variety of ways, including credit card, electronic payment and/or by invoice. In the final undertaking 15, the content platform 5 completes the transaction by remitting payment to the licensor.

In another embodiment, the content platform 5 will complete delivery of content to licensee's content management system 7 (action 13) only upon receipt of payment.

In yet another embodiment, the content platform 5 can be customized to restrict the sale of content from all or selected content creators until each uploaded work has been vetted for plagiarism by the authentication application 2.

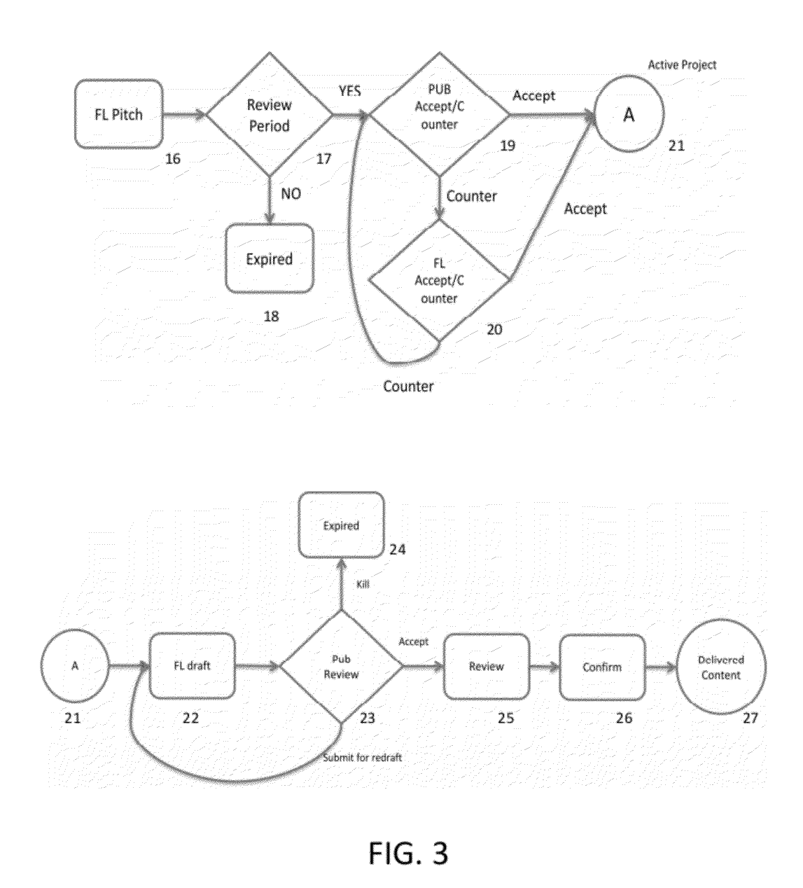

In the process depicted in FIG. 3, a creator can use the online marketplace portal to submit a proposal for a yet-to-be-completed work; content publishers can search for, identify, and purchase these pitches. In an initial action 16, a creator uploads a freelance pitch to the content platform 5 and declares it available for purchase and/or counterproposal. The content platform 5 stores the pitch for a predetermined “review period” (event 17); if no content licensee purchase the pitch or submit a counterproposal, the process ends with the pitch expiring 18.

A content licensee can indicate interest in a pitch by either purchasing it or submitting a counterproposal, which would include new suggested terms for the pitch (action 19). If the freelance creator accepts the content licensee's counterproposal (event 20), or if the content licensee accepts the creator's initial terms, then the content platform reclassifies the pitch as an active project 21. If the freelance creator does not accept the counterproposal, then the pitch is made available in the content platform 5 to other content licensees until the review period is completed.

Once the pitch becomes an active project 21, the freelance creator and content licensee can use the online marketplace portal to manage the project's progress from pitch to finished work. In one embodiment, the freelance creator completes a first draft of the work (event 22). In the next action 23, the content licensee reviews the draft, and either submits it back to the freelance creator for redraft, accepts the work, or kills the project. If the content licensee chooses to kill the project 24, the licensee can still be obligated to pay the freelance creator the pre-negotiated “kill fee,” if any exists. If the content licensee submits the draft back to the freelance creator for redraft, then the process can continue until the content licensee accepts a draft as a final draft.

Once the content licensee accepts a final draft, the content licensee can conduct a final review 25, and confirm purchase of the freelance creator's work (action 26) under the previously negotiated terms and conditions. The process ends with the feed platform 5 delivering the purchased work to the licensee's content management system 7 in a publishable format (event 27).

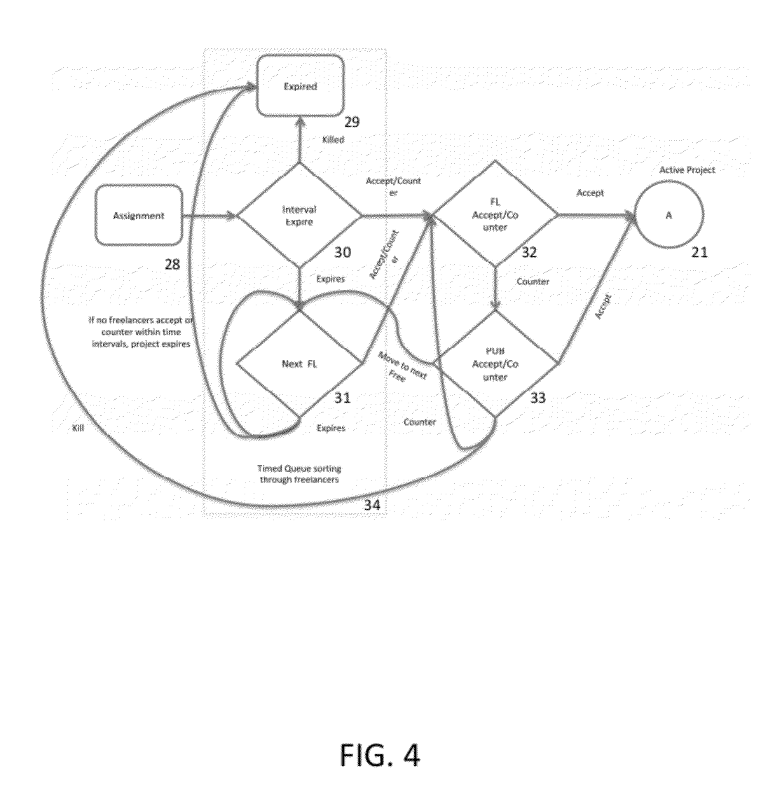

In the process in FIG. 4, content licensees can use the online marketplace portal to create assignments and either assign them to specific freelance creators, or make them available to a pool of freelance creators for selection. In one embodiment, the process begins by a content licensee submitting an assignment (action 28). The content platform 5 will store the assignment for a predetermined “review period.” Freelance creators have the option of selecting the assignment, rejecting it, or submitting a counterproposal (event 32).

In a further embodiment, a content licensee can generate a list of two or more freelance creators, ranked in order of preference. In another embodiment, the content licensee will be able to search, sort, and rank a list of freelance creators by a multiple of factors, including reputation, suggested compensation, and areas of expertise. The content platform 5 will initiate a sub-process 34 to grant the highest ranked freelance creator a period of time to review and accept the assignment; if the assignment is not accepted, the content platform 5 will then allow the next highest-ranked freelance creator an interval of time to review and accept the assignment (event 31).

If no freelance creator expresses interest in the assignment within the review period (action 30), then the content platform 5 designates the assignment as expired 29.

If a freelance creator accepts the assignment, then the content platform 5 designates the assignment to be an active project 21, and the process can continue as depicted in FIG. 3. If a freelance creator offers a counterproposal, then the content licensee can either accept the freelance creator's proposed terms and initiate an active project 20, provide a counter to the freelance creator's counterproposal, or resubmit the assignment to another freelance creator for selection (action 31). In one embodiment, the content licensee can authorize the content platform 5 to restart sub-process 34 and submit the assignment to the next highest-ranked freelance creator for selection (event 31). The process ends either with an accepted proposal, which is then reclassified as an active project 21, or with the expiration of the predetermined time frame, at which point the assignment is classified as expired 29.

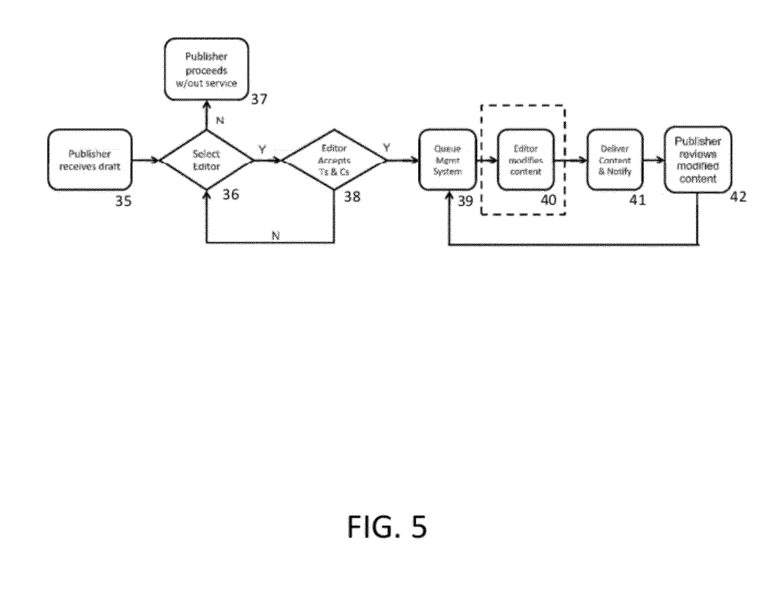

In the process in FIG. 5, a publisher begins with a draft of licensed content (event 35). The content here can be analogous to the content delivered by a content creator (e.g., event 27); or, the publisher can initiate the process using content generated by its own internal content creators. As a next action 36, the publisher selects an editor providing a desired post-content creation service from the array of editors participating in the marketplace portal. In various embodiments, the pool of editors participating in the marketplace portal can include freelance creators, third party service providers, and publishers seeking to capitalize on excess resource capacity in various content editing and modification functions. According to one aspect, a publisher can review, sort, and select from the list of editors based on reputation, cost, and other prevailing terms and conditions. In a further embodiment, the marketplace portal can automate the selection of the highest-ranked editor willing to agree to the publisher's terms and conditions, using an iterative decision routine analogous to the process described in FIG. 4. If the publisher cannot identify a participating editor that meets its needs or will agree to terms and conditions, the publisher can exit this sub-process (action 37).

When a selected editor agrees to the publisher's set terms and conditions (event 38), the marketplace portal then adds the content draft to that editor's queue management system 39, associated with that editor's profile in the marketplace portal. Editors can use the queue management system to monitor and manage the queue of assignments received from various publishers in the marketplace portal. In a further embodiment, editors can use the queue management system to identify high-priority assignments, such as time-sensitive tasks or jobs with an agreed upon “rush” fee. Editors comprised of multiple employees—e.g., a copy desk, film editing team, graphic arts firm, etc.—can use the queue management system to manage the distribution of assignments and work flow within the team.

As a subsequent action 40, the editor modifies the content draft offline, as per the terms and conditions agreed to with the publisher. The editor then uses the marketplace portal to deliver the modified content and notify the publisher of the task's completion (event 41). The process can end at event 42, with the publisher reviewing the modified content. Alternatively, the publisher can resubmit the work into the queue management system 39 for additional modification.

What is claimed is:

1. A method for obtaining post-content creation services from an editor, the method executing on a processor of a computer, comprising:
creating a licensor profile on a marketplace application operating on a processor residing on a server;
generating a list of editors using the marketplace application;
selecting an editor from the list of editors;
submitting a created work to the editor;
receiving a modified work based on the created work from the editor; and
submitting payment to the editor.

2. The method of claim 1, further comprising ranking the list of editors by preference.

3. The method of claim 1, further comprising automating a selection of a highest-ranked editor willing to agree to specific contract terms from the list of editors.

4. A system for obtaining post-content creation services from an editor on a processor of a computer, comprising:
a processor, residing on a server, configured to create a licensor profile on a marketplace application; and
a marketplace application, configured to generate a list of editors, wherein an editor is selected from said list of editors;
wherein said marketplace application facilitates the submission of created work to, the receiving of modified work from, and payment to said selected editor.

5. The system of claim 4, wherein said list of editors is ranked by preference.

6. The system of claim 4, wherein said list of editors is ranked by willingness to agree to specific contract terms.

7. A method for providing post-content creation services to a publisher, the method executing on a processor of a computer, comprising:
creating an editor profile on a marketplace application operating on a processor residing on a server;
selecting licensing contract terms;
accepting an offer from a publisher;
receiving a work from the publisher;
modifying the work to create a modified work;
submitting the modified work to the publisher; and
receiving payment from the publisher.

8. The method of claim 7, further comprising adding the work to a queue management database.

9. A system for providing post-content creation services to a publisher, executing on a processor of a computer, comprising:
a processor, residing on a server, configured to create an editor profile on a marketplace application; and
a marketplace application, configured to generate licensing contract terms for selection, capable of facilitating the acceptance and receipt of work from a publisher;
wherein said marketplace application facilitates modifying said work from a publisher to create a modified work, submitting said modified work to a publisher, and receiving a payment from said publisher.

10. The system of claim 9, further comprising a queue management database capable of storing the work.
